(19) United States
(12) Patent Application Publication
(10) Pub. No.: US 2004/0094004 A1
(43) Pub. Date: May 20, 2004

(54) Readily separable partially embossed wet wipe and methods of making same

(76) Inventor: Robert P. Julius, Greenwich, CT (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/295,075

(22) Filed: Nov. 15, 2002

(51) Int. Cl. B32B 3/00; B26D 3/00

(52) U.S. Cl. 83/39; 428/156

(57) ABSTRACT

The present invention relates to pre-moistened towelettes, often referred to as wet wipes. The wet wipes of the present invention include at least one substantially continuously embossed portion, typically along two opposing edges. Such substantially continuous embossing is sufficient to permit tactile and visual recognition of the edge to enable a user to quickly and efficiently isolate and secure the wipe, especially when in a folded configuration or placed atop a subsequent wipe in a stacked configuration. The substantially continuous embossing also reduces the peel force required to remove one wet wipe from atop another. Remaining portions of the wipe may also be discontinuously embossed. The invention also includes methods of manufacturing such wipes.

### BACKGROUND OF THE INVENTION

The present invention relates to pre-moistened towelettes, often referred to as wet wipes. Wet wipes have become increasingly popular among modern consumers for an array of uses. For example, when infants soil their diapers, caretakers typically find it convenient and effective to cleanse the soiled areas with wet wipes. Caretakers also often use wet wipes to cleanse the dirty hands and faces of toddlers, especially after particularly messy activities such as eating or playing outdoors. Even for adults, wet wipes are often provided at various restaurants for cleansing their hands and faces after certain meals.

Such wet wipes are generally packaged either individually or in a stacked arrangement. When configured in a stacked arrangement, the uppermost wet wipe is often difficult to separate from the subsequent wipe. This is especially true if the wipes are stacked without being folded, but is also true of folded wipes. Several factors cause this difficulty.

First, the uppermost wet wipe's edge has identical properties as the wipe below. For example, the color and texture is typically equivalent. This makes visual identification of the edge difficult. In addition, tactile recognition is impaired because the moist nature of the sheets causes them to have an affinity for one another.

Thus, when folded and then stacked, a user typically has to drag her fingers across the surface of the uppermost stacked wipe in an attempt to discern the location of the wipe's leading edge. This can be both frustrating and unsanitary. It is also a particular problem when, for instance, a user must secure an infant with one hand and obtain a wet wipe with the other.

Even upon location of the edge, it is often difficult to peel the uppermost wipe from the subsequent layer because, as stated, the moist wipes tend to have an affinity for one another. Prior art wet wipes have attempted to cure some of these deficiencies.

For example, U.S. Pat. No. 5,368,188 issued to Twardowski provides a wet wipe with a visual indicator along the leading edge to create a line of contrasting color. While this helps with visual recognition, it does not appear to promote tactile feel or reduce the peel force between successive wet wipes.

Another attempt is seen in U.S. Pat. No. 5,540,332 issued to Kopacz et al. This patent discloses a wet wipe having edges configured in non-linear patterns, such as sine waves. It is claimed that such edges are easily discerned, both visually and tactilely. In addition, the patent describes a resulting reduction in the peel force required to separate successive layers of wipes. However, room is still left in the art for improvement.

The present invention provides such improvements.

### SUMMARY OF THE INVENTION

In accordance with the present invention, a wet wipe where at least one section of the wipe is substantially continuously embossed is provided. Typically, two opposing edges of the wipe will be substantially continuously embossed, with a remaining portion of the wipe left unembossed. This arrangement provides visual and tactile distinction between the physically different areas. Alternatively, the wipe may be configured with at least one of the edges unembossed, and the remaining portion of the wipe substantially continuously embossed.

The substantially continuous embossing is preferably a plurality of lines extending linearly from, and perpendicular to the edge. The substantially continuously embossed lines preferably form a repeating pattern, so as to make the wipe look creped, but may also be randomly disbursed. Many other substantially continuous embossing patterns such as cross-hatching and non-linear lines may also be utilized, so long as there is a sufficient distinction between the substantially continuously embossed areas and the unembossed areas or discontinuously embossed areas so as to serve the function of enabling tactile and visual recognition of the different surfaces.

The nature of the embossing procedure causes the overall thickness of the wet wipe to vary throughout the embossed areas, where localized pressure distorts portions of the wipe's surface. Such embossing techniques are well known in the art.

Substantially continuously embossing an edge of a wipe serves several functions. First and foremost, it provides tactile and visual indication of the leading edge of the wet wipe by its distinctive texture. This is particularly useful when trying to grasp a single wet wipe from a stack of wipes. In addition, it reduces the peel force required to separate wipes from one another once the initial wipe is secured. Finally, many consumers find substantially continuously embossed wet wipes aesthetically pleasing.

The embossing techniques of the present invention leave a remaining portion unembossed. In this remaining portion, it may be desirable to provide additional aesthetically pleasing discontinuously embossed patterns. Such discontinuously embossed patterns may vary according to the intended use of the product. In applications where the wet wipes will be used for the cleansing of infants, such patterns may include bears, balloons, clowns, flowers or other designs typically known in the art. If the wet wipes are to be used for adults, such as when cleansing their hands and faces after consuming particularly messy meals, such patterns may include lobsters, racks of ribs, hamburgers or the like. Many additional uses and discontinuous embossing patterns have also been contemplated, and are generally known in the art.

In addition to being aesthetically pleasing, such discontinuous embossing serves the function of providing a wipe of relatively uniform thickness, at least in the localized embossed areas. This helps to ensure that a stack of wipes will stack neatly and uniformly.

Similar discontinuous embossing techniques are known in the art. For example, U.S. Pat. No. 6,361,784 issued to Brennan, et al. and U.S. Pat. No. D400,716 issued to Sporting, et al. disclose wet wipes with discontinuously embossed icons, or images. In U.S. Pat. No. 6,361,704, the discontinuously embossed icons have a consistent icon diameter. When a continuous web of such wipes is cut into single wipes, several of the icons may also be cut, and thus appear at an edge. Functionally, this edge embossing does not have the same effect as the substantially continuous embossing of the present invention. The present invention is directed towards substantially continuously embossed areas which function to provide visual and tactile recognition of an edge of a wet wipe. A single embossed image, or even a series of embossed images of the type discussed in U.S. Pat. No. 6,361,784 occurring at an edge will not serve this function.

Similarly, U.S. Pat. No. D400,716 includes a plurality of discontinuously embossed images. These images generally occur at the center of the wipe, with the wipe's edges unembossed. However, when the unembossed edges are folded over onto the discontinuously embossed images, the discontinuously embossed images will occur at an edge. Notwithstanding, these discontinuously embossed images are not sufficient to function in the manner of those of the present invention.

In one embodiment of the present invention, a wet wipe comprises first and second side edges and first and second end edges extending between the first and second side edges. The wipe further comprises a first area adjacent to the first side edge and a remaining area adjacent to the first area. A first boundary separates the first area from the remaining area and extends from the first end edge. At least one of the first area or at least a portion of the remaining area is substantially continuously embossed such that the substantially continuous embossing provides tactile and visual recognition of the wipe.

The first and second end edges may be transverse to the first and second side edges.

The first boundary may extend from the first end edge to the first side edge.

The first boundary may also extend from the first end edge to the second end edge.

The remaining area of the wet wipe may further comprise a second boundary extending from the first end edge to define a second area adjacent to the second side edge and a third area between the first area and the second area.

The first area may extend from the first side edge a predetermined distance and the second area may extend from the second side edge a distance substantially equal to the predetermined distance.

The first area and the second area may be substantially continuously embossed at least partially along the length of the first side edge and the second side edge.

The first area may be substantially continuously embossed with a plurality of embossed lines extending in a first direction and the second area may be substantially continuously embossed with a plurality of embossed lines extending in a second direction.

The first direction and the second direction may each be perpendicular to the side edges.

The first direction may also be normal to the second direction.

The first area and the second area may be substantially continuously embossed at least partially along the length of the first boundary and the second boundary.

The substantially continuously embossed areas may comprise a plurality of embossed non-linear lines.

The substantially continuously embossed areas may comprise a plurality of embossed lines arranged in a cross-hatched pattern.

The third area may include a plurality of discontinuously embossed images.

The third area may also be substantially continuously embossed.

The first area and the second area may include a plurality of discontinuously embossed images.

In another embodiment of the present invention, a plurality of wet wipes arranged in this stacked configuration may be provided. Each of the wet wipes in a stacked configuration may comprise first and second side edges and first and second end edges extending between the first and second side edges. The wipes may also comprise a first area adjacent to the first side edge and a remaining area adjacent to the first area. A first boundary may separate the first area from the remaining area of each wipe. The first boundary may extend from the first end edge. At least one of the first area or at least a portion of the remaining area may be substantially continuously embossed such that the substantially continuous embossing provides tactile and visual recognition of the wipe.

The first boundary of each wipe may extend from the first end edge to the second end edge of each wipe.

The remaining area may further comprise a second boundary extending from the first end edge to define a second area adjacent to the second side edge and a third area between the first area and the second area.

The first area may extend from the first side edge a predetermined distance and the second area may extend from the second side edge a distance substantially equal to the predetermined distance.

The first area and the second area of each wipe may be substantially continuously embossed.

The third area of each wipe may be substantially continuously embossed.

Each of the plurality of wipes may further comprise a first fold line oriented transverse to the end edges and proximate to the first area. Each of the wipes may then be folded along the first fold line.

Each of the plurality of wipes may also comprise a first fold line and a second fold line where the first fold line is oriented transverse to the end edges and proximate to the first area and the second fold line is oriented transverse to the end edges and proximate to the second area. Each of the wipes may be folded along the first and second fold lines.

A method of manufacturing a plurality of wet wipes may include providing a continuous web of material having a first edge and a second edge, a first area extending from the first edge, a second area extending from the second edge, and a remaining portion between the first area and the second area. The method may include substantially continuously embossing the first area and the second area of the web. It may further include cutting the web at predetermined intervals from the first edge to the second edge to create a plurality of wipes. The method may also include applying a moistening solution to each of the wipes to create a plurality of wet wipes.

The method may further comprise the step of discontinuously embossing the remaining portion of the web with a plurality of embossed images.

Another method of manufacturing a plurality of wet wipes comprises the step of providing a continuous web of material having a first edge and a second edge, a first area extending from the first edge, a second area extending from the second edge, and a remaining portion between the first and second areas. The method may also include substantially continuously embossing the remaining portion of the web and cutting the web at predetermined intervals from the first edge to the second edge to create a plurality of wipes. The method may also include applying a moistening solution to each of the wipes to create a plurality of wet wipes.

This method may also include the step of discontinuously embossing at least one of the first area and the second area of the wipe with a plurality of embossed images.

A still further method of manufacturing a plurality of wet wipes comprises the step of providing a continuous web of material having a first edge and a second edge. The method may also include substantially continuously embossing the web between the first edge and the second edge at predetermined intervals to form substantially continuously embossed areas separated by remaining portions of the web. The method may also include cutting each of the substantially continuously embossed areas from the first edge to the second edge to create a plurality of wipes. It may also include applying a moistening solution to each of the wipes to create a plurality of wet wipes.

The method may further comprise the step of discontinuously embossing each of the remaining portions of the wipe with a plurality of embossed images.

### DESCRIPTION OF THE DRAWINGS

FIG. 1 depicts a top plan view of a wet wipe in accordance with one embodiment of the present invention;

FIG. 2 illustrates a perspective view of a plurality of the wet wipes of FIG. 1 in a stacked configuration;

FIG. 3 is a perspective view of a wet wipe in accordance with another embodiment of the present invention in a partially folded configuration;

FIG. 4 illustrates a perspective view of a plurality of wet wipes of FIG. 3 in a fully folded and stacked configuration;

FIG. 5 depicts a perspective view of the wet wipes of FIG. 4 packaged in a container;

FIG. 6 is a perspective view of an initial step in both of the methods of manufacturing wet wipes in accordance with the present invention;

FIG. 7 illustrates a further step in one of the methods of manufacturing wet wipes of the present invention;

FIG. 8 depicts another step in the method of manufacturing wet wipes shown in FIG. 7;

FIG. 9 illustrates a subsequent step in the second method of manufacturing wet wipes of the present invention;

FIG. 10 depicts another step in the second method of manufacturing wet wipes shown in FIG. 9;

FIGS. 11-13 illustrate top plan views of wet wipes in accordance with other embodiments of the present invention;

FIG. 14 depicts one step in the method of embossing a continuous web of material as known in the art;

FIG. 15 illustrates a detailed view of one aspect of the step in the method of embossing a continuous web of materials shown in FIG. 14; and

FIGS. 16 and 17 illustrate top plan views of wet wipes in accordance with further embodiments of the present invention.

### DETAILED DESCRIPTION

In the following is described the embodiments of the readily separable partially embossed wet wipe and method of the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose. In this regard, the wipes described herein are generally presented with two substantially continuously embossed areas extending from opposing edges. However, it should be understood that the wipe may be configured in different manners, including a single substantially continuously embossed edge, three substantially continuously embossed edges, four substantially continuously embossed edges, or a central substantially continuously embossed portion with no embossed edges.

Materials used to form wipes of the type contemplated herein are generally well known in the industry. They may include standard air-laid fabrics, spunlaced fabrics, co-formed products, wet-laid nonwovens, or the like. These materials are then processed and combined with moistening solutions. Such solutions are also typically well known in the industry. They may include cleansing compounds, polishes, cosmetic mixtures, disinfectants, or combinations thereof.

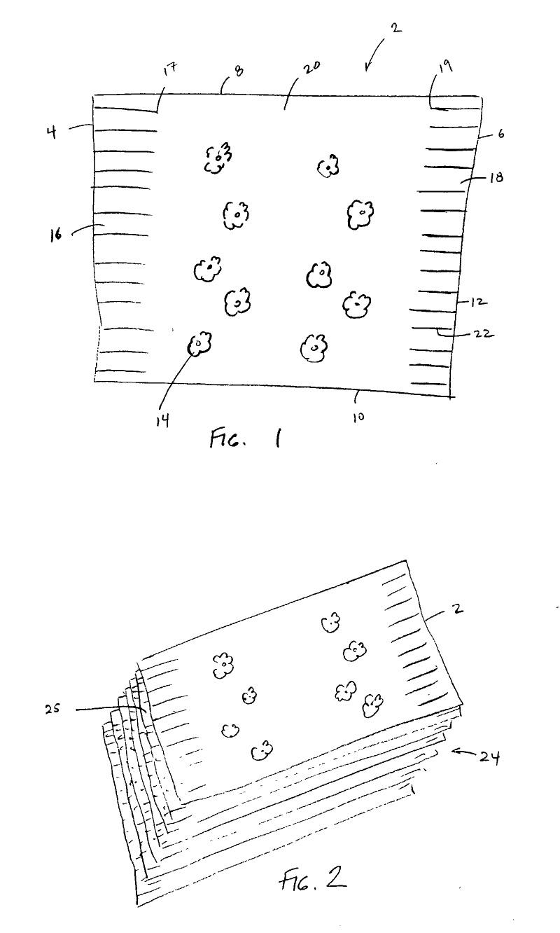

Referring to the figures, FIG. 1 depicts a top plan view of a wet wipe 2 in accordance with a preferred embodiment of the present invention. In accordance with this embodiment, the wet wipe 2 is of a generally rectangular configuration and comprises a first edge 4 and an opposing second edge 6. Third and fourth opposing edges 8, 10 are arranged between and typically perpendicular to the first and second edges 4, 6. Together, the edges 4, 6, 8 and 10, combine to create continuous border 12. In this preferred embodiment, the first and second edges 4, 6, are approximately 190 mm in length while the third and fourth edges are approximately 206 mm in length. Of course, other dimensions are contemplated, depending on the product's intended purpose.

As further shown in FIG. 1, the first edge 4 marks an exterior end of a first area 16 and the second edge 6 marks an exterior end of a second area 18. Each area 16, 18 extends partially towards each other and terminates at respective interior ends 17, 19. The interior end 17 of the first area 16 and the interior end 19 of the second area 18 define a remaining portion 20 of the wet wipe 2 therebetween. The first and second areas 16, 18 are each substantially continuously embossed, such that localized pressure may be used to alter the thickness and resulting texture of the wipe. Such embossing techniques are well known in the art, and will be described hereinafter.

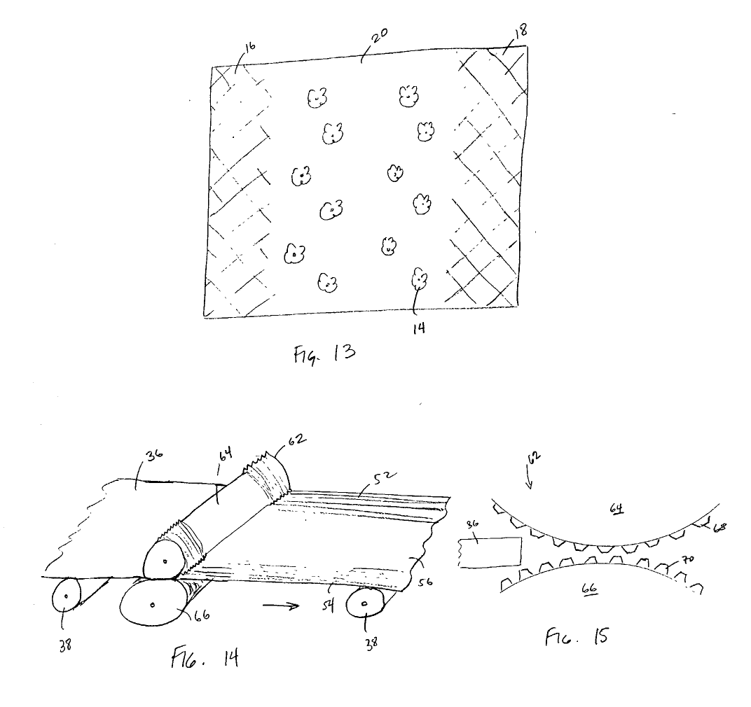

The substantially continuous embossment of the first and second areas 16, 18 may be applied in a variety of patterns, such as linear lines, non-linear lines, cross-hatching, circular patterns, embossed dots, or the like. The patterns typically repeat, but need not if a random pattern is desired. What is essential, however, is that the embossed patterns be sufficiently close together that they can be contrasted with non-embossed areas of the wipe 2 or discontinuously embossed areas of the wipe. The substantially continuous embossing is also sufficient to leave gaps between successive layers of substantially continuously embossed wipes. A wet wipe with a cross-hatched substantially continuous pattern in the first and second areas 16, 18 and a random discontinuous flower pattern in the remaining portion 20 is shown in FIG. 13. Other wipes will be depicted hereinafter.

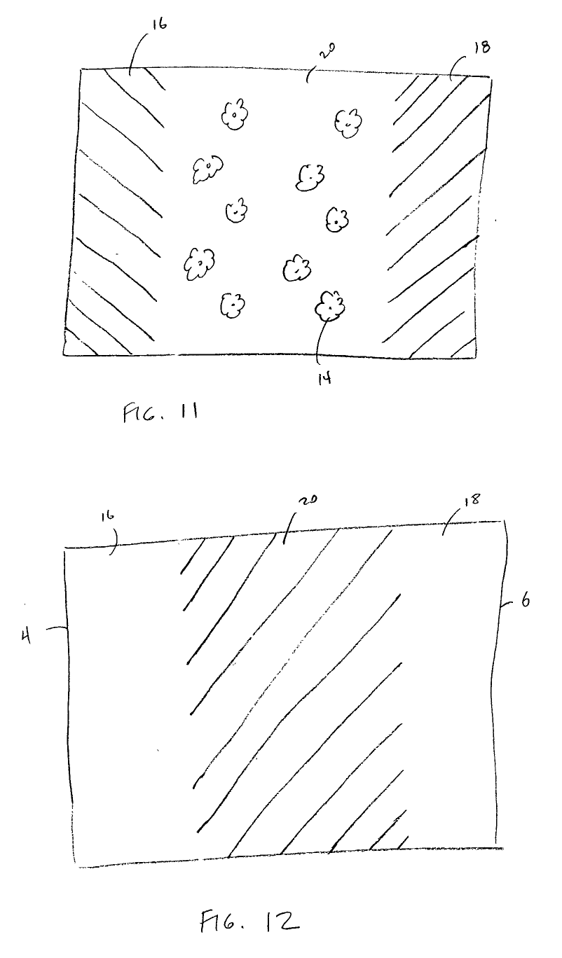

Each area of the wipe 2 may be embossed with different patterns. For example, the first area 16 may be substantially continuously embossed with lines projecting 45° from a given axis and the second area 18 may be substantially continuously embossed with lines projecting 135° from the given axis, such that the sets of lines are at right angles to each other. An example of such a wipe is shown as FIG. 11 which also includes an interior discontinuously embossed flower pattern.

The preferred pattern is shown in FIG. 1. In this preferred pattern, the substantially continuous embossing is conducted in a series of lines 22. For the typically sized wet wipe previously discussed, it has been found that such lines 22 are most functional when they are approximately 37 mm in length, 2 mm in width, and spaced at 4 mm intervals. Other dimensions may also be used, however.

As further depicted in FIG. 1, the remaining portion 20 of the wipe 2 may comprise additional discontinuously embossed patterns 14. Unlike the first and second substantially continuously embossed areas 16, 18, which are functionally utilized for tactile and visual recognition as well as reduced adherence to subsequent layers, the discontinuously embossed patterns 14 are typically included for aesthetic purposes and to provide a more consistent thickness throughout the wipe. This consistent thickness permits a number of wipes to be stacked without portions of the stacked wipe being bulkier than other portions. The discontinuously embossed patterns 14 may be of any number of figures or designs, such as bears, flowers and lobsters, as previously discussed.

It will be appreciated that the wet wipe 2 may also be configured opposite to the arrangement shown in FIG. 1. For example, the wipe 2 may be substantially continuously embossed in the remaining portion 20 and not embossed in the first or second areas 16, 18. In such an arrangement, however, the physical distinction between the various areas is maintained, thus serving an intended purpose of the invention. Such a configuration is shown in FIG. 12, where the remaining portion 20 of the wipe 2 is substantially continuously embossed with diagonal lines and the first area 16 and second area 18 are left unembossed. In such a configuration, the first area 16 or second area 18 will typically be folded over to place the unembossed first edge 4 and/or second edge 6 in communication with the embossed remaining portion 20. This provides a distinction between the substantially continuously embossed and unembossed portions of the wipe.

Other embodiments of the wet wipe 2 of the present invention contemplate only a single substantially continuously embossed area 16. For example, as illustrated in FIG. 16, a wipe may comprise a single substantially continuously embossed area 16 between a portion of first edge 4 and the interior end 17 of area 16. As is shown, the interior end 17 may extend between third edge 8 and first edge 4. As shown in FIG. 17, the interior end 17 of substantially continuously embossed area 16 may also terminate within the remaining area of the wipe 2, without ending at an edge 4, 6, 8 or 10.

For sake of clarity, this specification continues with reference to the first embodiment, where the first area 16 and second area 18 are substantially continuously embossed, and the remaining portion 20 is not.

FIG. 2 depicts a plurality of wet wipes 2 in a stacked configuration 24. In this embodiment, each wet wipe 2 is in an unfolded, planar condition, and is successively stacked upon a previously placed wet wipe 2. It will be appreciated that the substantially continuously embossed areas 16, 18 of the uppermost wipe 2 enable a user to visually and tactilely distinguish the uppermost wipe from the remainder of the stack 24. This is true despite the fact that the substantially continuously embossed areas 16, 18 of the uppermost wipe 2 are directly above the substantially continuously embossed areas 16, 18 of the successive wipe. Because the embossing procedure creates wipes 2 with continuous borders 12 of varying thickness, successive wipes have a reduced affinity for one another along the continuous border. Further, the uneven thickness permits gaps 25 to form between successive wipes. Often, a user will be able to lift the uppermost wipe 2 simply by locating a gap 25 and inserting a finger therein to isolate and peel the uppermost wipe 2 from the stack 24. The peel force required in the substantially continuously embossed areas 16, 18 is advantageously less than that required for a stack of typical flat wipes.

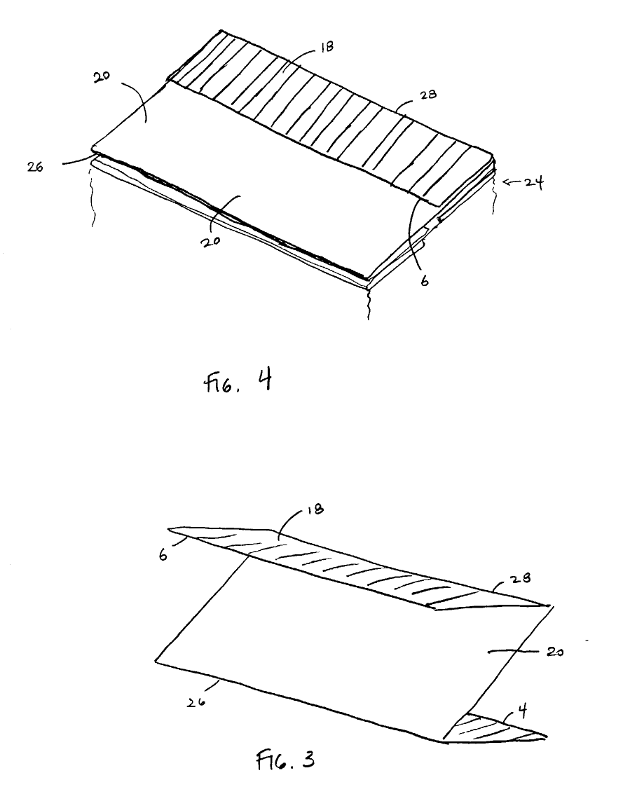

FIG. 3 illustrates a single wipe 2 in a partially folded condition. Many such folding techniques are possible, and are known in the art. Examples include the Z-fold, C-fold, and quarter fold. However, for ease of description, FIG. 3 depicts a typical Z-fold, as known in the art.

To place the wipe 2 in such a folded condition, the first edge 4 is folded under the wipe along a first fold line 26. The second edge 6 is then folded over the wipe 2 along a second fold line 28 as shown in FIG. 3. The wipe is then pressed flat. It will be appreciated that first fold line 26 may be at the interior end 17 of first area 16 and second fold line 28 may be at the interior end 19 of second area 18.

An example of a completely folded wipe 2 is shown in FIG. 4, where a plurality of folded wipes 2 are stacked in a folded configuration. When placed in such a configuration, it will be appreciated that the second edge 6, being substantially continuously embossed, is visually and tactilely distinguishable from the remaining portion 20 it rests upon. This distinction enables a user to readily discern the second edge 6 and easily peel the uppermost wipe 2 from the remainder of the stack 24.

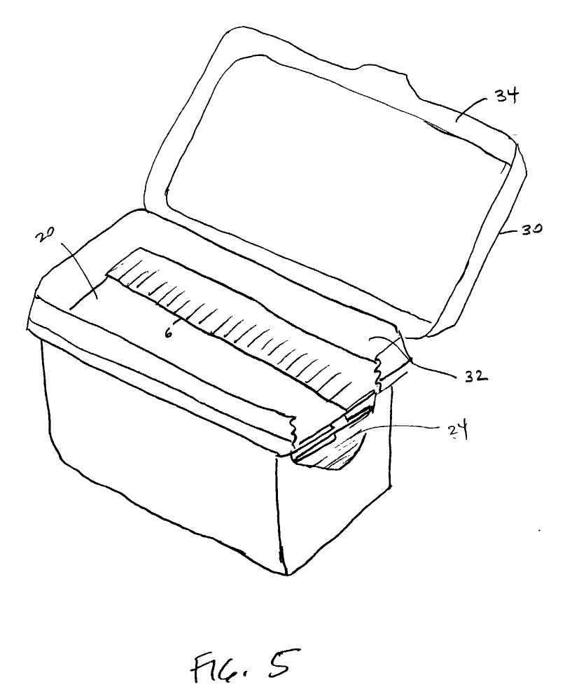

FIG. 5 depicts a container 30, having an interior portion 32, for housing a stack of wipes 24. When the container 30 is used to store an unfolded stack of wipes 24 (not shown), the container is typically oversized, such that there is sufficient space between the continuous border 12 and the interior portion 32 of the container to permit an individual to grasp a wipe from any of its edges 4, 6, 8 or 10. When the container 30 is used to store a folded stack of wipes 24, as shown in FIG. 5, the interior portion 32 is generally sized to snugly fit the stack of wipes 24. Notwithstanding, an individual may still grasp the second edge 6, of the uppermost wipe 2, when folded in a Z-fold, or other edges 4,8,10 if folded in other manners.

The container may additionally include a cover 34, to prevent moisture from the wipes from escaping when not in use. Containers 30 of this type are well known in the art. Other containers may also be utilized.

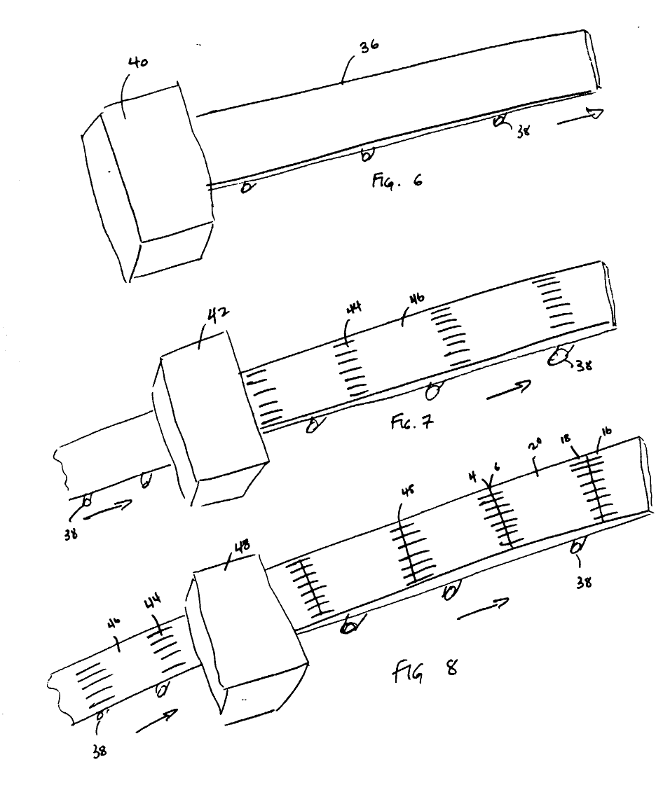

Techniques for creating the wet wipes of the present invention are similar to those presently known in the industry. The following depicts a method of creating wet wipes in accordance with the preferred embodiment show in FIG. 1. As shown in FIG. 6, a continuous web of unadulterated wet wipes 36 is fed along a series of conveyors 38 from a first processing unit 40. The continuous web travels along the conveyor 38 to a second processing unit 42. The second processing unit 42 repeatedly substantially continuously embosses the wipe in embossed areas 44 separated by remaining portions 46 of the web, as shown in FIG. 7. The continuous web 36 then continues to a third processing unit 48 where it is successively scored or cut across the full width of the web along the mid-line 45 of each substantially continuously embossed area 44, as shown in FIG. 8. This cut line defines the first edge 4 of a given wipe 2 and the second edge 6 of the successive wipe of the web 36. It will also be appreciated that portions of the substantially continuously embossed area 44 become the first substantially continuously embossed area 16 of a given wipe 2 and the second substantially continuously embossed area 18 of the successive wipe. Finally, the entirety of the remaining portion 46 of the continuous web 36 becomes the remaining portion 20, of a given wipe 2. Following this procedure, a moistening solution (not show) is introduced to the wipes 2 to create a wet wipe.

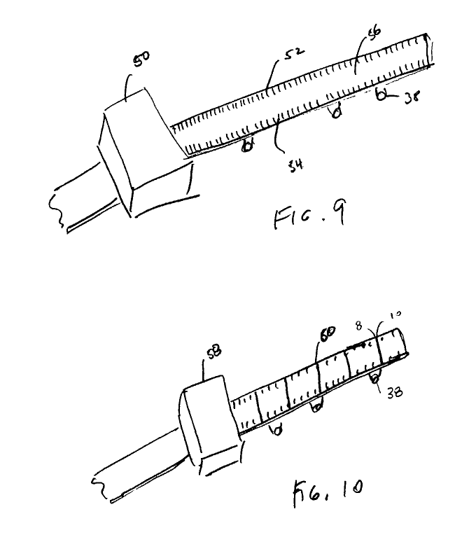

The wet wipe may also be manufactured by alternate methods. One of these alternate methods is shown in FIGS. 6, 9 and 10. Beginning with FIG. 6, a continuous web of unadulterated wet wipes 36 is fed along conveyors 38 from a first processing unit 40, as before. The continuous web travels along the conveyors 38 to a second processing unit 50, as shown in FIG. 9. The second processing unit 50 substantially continuously embosses the wipe in uninterrupted embossed areas 52, 54, separated by a continuous remaining portion 56 of the web. The continuous web 36 then continues to a third processing unit 58, as shown in FIG. 10, where it is successively scored or cut along lines 60 at predetermined intervals. This cut is made across the full width of the of the continuous web 36. Each cut line 60 defines the fourth edge 10 of a given wipe and the third edge 8 of the subsequent wipe. It will also be appreciated that portions of the substantially continuously embossed areas 52, 54 become the first substantially continuously embossed area 16 and the second substantially continuously embossed area 18 of a given wipe 2. Finally, the portion of the of remaining portion of the web 56 between successive cut lines 60 becomes the remaining portion 20 of a given wipe 2. After this procedure is complete, a moistening solution (not show) is introduced to the wipes 2 to create a wet wipe.

It will be appreciated that although the substantially continuously embossed areas 16, 18 of several embodiments have been generally described as each being of equal area, they are not necessarily configured in such a manner. This difference may be either by design, such as for aesthetic purposes, or due to machining tolerances. Notwithstanding, the distinction between the substantially continuously embossed areas 16, 18 and the remaining portion of the wipe 20 will remain.

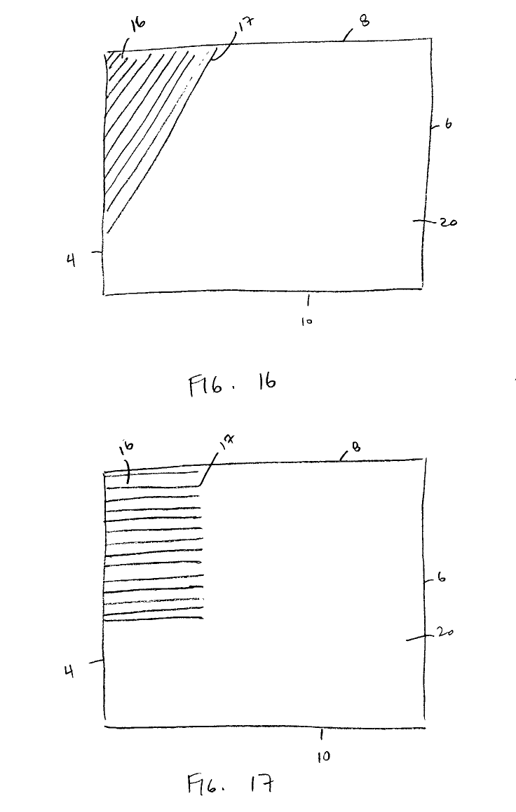

Techniques for embossing continuous webs of wipes 36 are typically known in the industry. As is shown in FIG. 14, the continuous web of wipes 36 is fed along a conveyor 38 into an embossing element 62. The embossing element comprises an upper embossing roller 64 and a lower embossing roller 66. Each of the embossing rollers 64, 66 contain a series of embossing elements 68, 70 (FIG. 15) in predetermined areas of the rollers. As the continuous web of wipes 36 is conveyed through the embossing element 62, the continuous web is embossed in predetermined areas corresponding to the areas of the upper and lower embossing elements 64, 66 which contain embossing elements 68. As shown in FIG. 14, the embossed wipe may contain a first substantially continuously embossed area 52, a second substantially continuously embossed area 54 and a remaining portion of the web 56.

FIG. 15 depicts a detailed view of a continuous web of wipes 36 entering a portion of the embossing element 62. As is shown, the continuous web of wipes 36 enters the embossing unit 62 where it is engaged by the embossing element 68 of the upper embossing roller 64 and embossing element 70 of the lower embossing roller 66. This engagement induces sufficient pressure upon the continuous web of wipes 36 such that the continuous web is permanently deformed in localized areas, thus becoming embossed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A wet wipe comprising:
first and second side edges;
first and second end edges extending between said first and second side edges;
a first area adjacent to said first side edge;
a remaining area adjacent to said first area;
a first boundary separating said first area from said remaining area;
wherein said first boundary extends from said first end edge; and
wherein at least one of said first area or at least a portion of said remaining area is substantially continuously embossed such that said substantially continuous embossing provides tactile and visual recognition of said wipe.

2. A wet wipe as claimed in claim 1, wherein said first and second end edges are transverse to said first and second side edges.

3. A wet wipe as claimed in claim 1, wherein said first boundary extends from said first end edge to said first side edge.

4. A wet wipe as claimed in claim 1, wherein said first boundary extends from said first end edge to said second end edge.

5. A wet wipe as claimed in claim 4, wherein said remaining area further comprises a second boundary extending from said first end edge to define a second area adjacent to said second side edge and a third area between said first area and said second area.

6. A wet wipe as claimed in claim 5, wherein said first area extends from said first side edge a predetermined distance and said second area extends from said second side edge a distance substantially equal to said predetermined distance.

7. A wet wipe as claimed in claim 5, wherein said first area and said second area are substantially continuously embossed at least partially along the length of said first side edge and said second side edge.

8. A wet wipe as claimed in claim 7, wherein said first area is substantially continuously embossed with a plurality of embossed lines extending in a first direction and said second area is substantially continuously embossed with a plurality of embossed lines extending in a second direction.

9. A wet wipe as claimed in claim 8 wherein said first direction and said second direction are each perpendicular to said side edges.

10. A wet wipe as claimed in claim 8 wherein said first direction is normal to said second direction.

11. A wet wipe as claimed in claim 5, wherein said first area and said second area are substantially continuously embossed at least partially along the length of said first boundary and said second boundary.

12. A wet wipe as claimed in claim 7, wherein said substantially continuously embossed areas comprise a plurality of embossed non-linear lines.

13. A wet wipe as claimed in claim 7, wherein said substantially continuously embossed areas comprise a plurality of embossed lines arranged in a cross-hatched pattern.

14. A wet wipe as claimed in claim 7, wherein said third area includes a plurality of discontinuously embossed images.

15. A wet wipe as claimed in claim 5, wherein said third area is substantially continuously embossed.

16. A wet wipe as claimed in claim 15, wherein said first area and said second area include a plurality of discontinuously embossed images.

17. A plurality of wet wipes arranged in a stacked configuration wherein each of said wet wipes comprises:
first and second side edges;
first and second end edges extending between said first and second side edges;
a first area adjacent to said first side edge;
a remaining area adjacent to said first area;
a first boundary separating said first area from said remaining area;
wherein said first boundary extends from said first end edge; and
wherein at least one of said first area or at least a portion of said remaining area is substantially continuously embossed such that said substantially continuous embossing provides tactile and visual recognition of said wipe.

18. The plurality of wet wipes arranged in a stacked configuration as claimed in claim 17, wherein said first boundary extends from said first end edge to said second end edge.

19. The plurality of wet wipes arranged in a stacked configuration as claimed in claim 18, wherein said remaining area further comprises a second boundary extending from said first end edge to define a second area adjacent to said second side edge and a third area between said first area and said second area.

20. A wet wipe as claimed in claim 19 wherein said first area extends from said first side edge a predetermined distance and said second area extends from said second side edge a distance substantially equal to said predetermined distance.

21. A wet wipe as claimed in claim 19, wherein said first area and said second area are each substantially continuously embossed.

22. A wet wipe as claimed in claim 19, wherein said third area is substantially continuously embossed.

23. The plurality of wet wipes arranged in a stacked configuration as claimed in claim 17, wherein each of said plurality of wipes further comprises a first fold line oriented transverse to said end edges and proximate to said first area, wherein each of said wipes is folded along said first fold line.

24. The plurality of wet wipes arranged in a stacked configuration as claimed in claim 19, wherein each of said plurality of wipes further comprises a first fold line and a second fold line, said first fold line oriented transverse to said end edges and proximate to said first area and said second fold line oriented transverse to said end edges and proximate to said second area, wherein each of said wipes is folded along said first and second fold lines.

25. A method of manufacturing a plurality of wet wipes comprising the steps of:
providing a continuous web of material having a first edge and a second edge, a first area extending from said first edge, a second area extending from said second edge, and a remaining portion between said first area and said second area;
substantially continuously embossing said first area and said second area of said web;
cutting said web at predetermined intervals from said first edge to said second edge to create a plurality of wipes; and
applying a moistening solution to each of said wipes to create a plurality of wet wipes.

26. The method of manufacturing a plurality of wet wipes as claimed in claim 25 further comprising the step of discontinuously embossing said remaining portion of said web with a plurality of embossed images.

27. A method of manufacturing a plurality of wet wipes comprising the steps of:
providing a continuous web of material having a first edge and a second edge, a first area extending from said first edge, a second area extending from said second edge, and a remaining portion between said first and said second area;
substantially continuously embossing said remaining portion of said web;
cutting said web at predetermined intervals from said first edge to said second edge to create a plurality of wipes; and
applying a moistening solution to each of said wipes to create a plurality of wet wipes.

28. The method of manufacturing a plurality of wet wipes as claimed in claim 27 further comprising the step of discontinuously embossing at least one of said first area and said second area of said wipe with a plurality of embossed images.

29. A method of manufacturing a plurality of wet wipes comprising the steps of:
providing a continuous web of material having a first edge and a second edge;
substantially continuously embossing said web between said first edge and said second edge at predetermined intervals to form substantially continuously embossed areas separated by remaining portions of said web;
cutting each of said substantially continuously embossed areas from said first edge to said second edge to create a plurality of wipes; and
applying a moistening solution to each of said wipes to create a plurality of wet wipes.

30. The method of manufacturing a plurality of wet wipes as claimed in claim 29 further comprising the step of discontinuously embossing each of said remaining portions of said wipe with a plurality of embossed images.
